(19) United States
(12) Patent Application Publication
(10) Pub. No.: US 2007/0098538 A1
(43) Pub. Date: May 3, 2007

(54) Mount apparatus and method for attaching three-point hitch implements to front arms of a front-end loader

(76) Inventor: Daniel M. Zettel, West Branch, MI (US)

Correspondence Address: HARNESS, DICKEY & PIERCE, P.L.C., P.O. BOX 828, BLOOMFIELD HILLS, MI, 48303, US

(21) Appl. No.: 11/589,650

(22) Filed: Oct. 30, 2006

Related U.S. Application Data
(60) Provisional application No. 60/732,467, filed on Nov. 1, 2005.

(51) Int. Cl. B66C 23/00; A01B 59/06

(52) U.S. Cl. 414/723; 172/439

(57) ABSTRACT

A mounting apparatus for mounting a three-point implement to a front arm loader is disclosed. The apparatus has a bracket disposed between the front arms of the front arm loader and a quick-coupler mechanism. The bracket provides four mounting points for rotational coupling to a pair of control link arms and lower arms. Three mounting locations are provided for coupling the quick-coupler to the bracket.

### CROSS-REFERENCE TO RELATED APPLICATIONS

This application claims the benefit of U.S. Provisional Application No. 60/732,467, filed on Nov. 1, 2005. The disclosure of the above application is incorporated herein by reference.

### FIELD

The present disclosure relates generally to a mount apparatus for three-point hitch implements, and more particularly to mount apparatus for attaching three-point hitch implements to front loader arms of a front-end loader.

### BACKGROUND

The statements in this section merely provide background information related to the present disclosure and may not constitute prior art.

Typically, three-point hitch implements, such as landscape rakes, augers and various blades are arranged to be pulled behind a tractor by attaching the implements to a rear end of a tractor via a three-point hitch. To facilitate attaching the implements to the three-point hitch, commonly a quick-hitch apparatus is attached to a pair of outer or draft links and an upper center link of the three-point hitch. The quick-hitch apparatus has hooks adapted for quick attachment to three-point hitch attachment locations on the implement. Though the implements are generally effective when being pulled behind the tractor, the degree of freedom for maneuvering the implements can be limited. As such, the implements may not be able to access some tight or otherwise difficult to reach areas, such as ditches, or the tractor may get stuck while attempting to maneuver the implement to the desired location.

### SUMMARY

To overcome the deficiencies of the prior art, a mounting apparatus for attaching a three-point hitching implement to the front arms of a front-end loader are provided. The mounting apparatus has a bracket disposed between the front arms of the front arm loader and the quick-coupler mechanism. In this regard, the bracket provides four mounting points for rotational coupling to a pair of control link arms and lower arms. Three mounting locations are provided for coupling the quick-coupler to the bracket.

In one embodiment, a mounting apparatus is provided which has an upper hook and a pair of lower hooks. The upper and lower hooks are adapted for direct attachment to a three-point hitch implement. These hooks are coupled to a generally planar body which is coupled to a quick attach face plate having a pair of flanges extending laterally from the body. Each flange defines a pair of openings adapted for pivotal attachments to a front arm of a front arm loader. The front arms each have top and bottom arms. The brackets are rotationally coupled to the top and bottom arms to form a four-bar linkage.

Further disclosed is a method for attaching a three-point hitch implement to a pair of control link arms and front loader arms of a front-end loader. A quick attach face plate is attached to the control link arms via a pair of generally parallel flanges. A three-point quick-hitch apparatus is removably coupled to the quick attach face plate. A three-point hitch implement is then coupled to upper and lower hooks of the three-point quick-hitch apparatus.

Further areas of applicability will become apparent from the description provided herein. It should be understood that the description and specific examples are intended for purposes of illustration only and are not intended to limit the scope of the present disclosure.

### DRAWINGS

Some of the objects, features and advantages of the invention will become readily apparent in view of the following detailed description of presently preferred embodiments and best mode, appended claims, and accompanying drawings, in which:

FIG. 1 is a perspective view of a mount apparatus according to one presently preferred embodiment shown attached to a pair of front loader arms of a front-end loader;

FIG. 2 is a side view similar to FIG. 1 with a quick-hitch apparatus attached to the mount apparatus to facilitate attaching three-point implements to the front loader arms;

FIG. 3 is a side view similar to FIG. 2 with a wheeled cart having three-point hitch attachment points attached to the front loader arms via the quick-hitch apparatus and mount apparatus;

FIGS. 4 and 5 represent exploded front and rear perspective views of the mount apparatus with quick-hitch apparatus shown in FIG. 2;

FIGS. 6A and 6B represent perspective views of a mount apparatus according to a second embodiment of the invention; and

FIGS. 7 and 8 represent rear perspective views of the mount apparatus shown in FIGS. 6A and 6B.

### DETAILED DESCRIPTION

The following description is merely exemplary in nature and is not intended to limit the present disclosure, application, or uses.

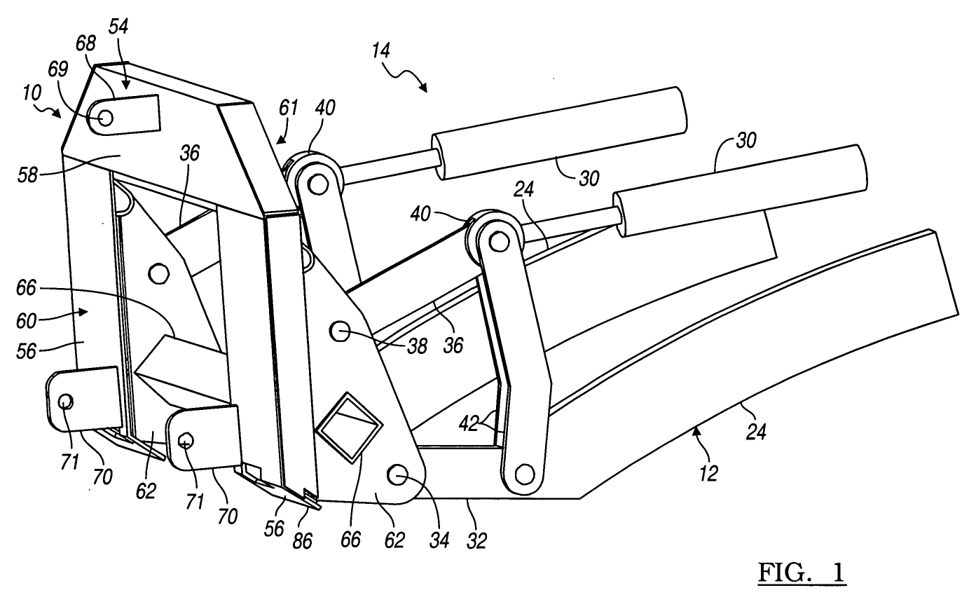

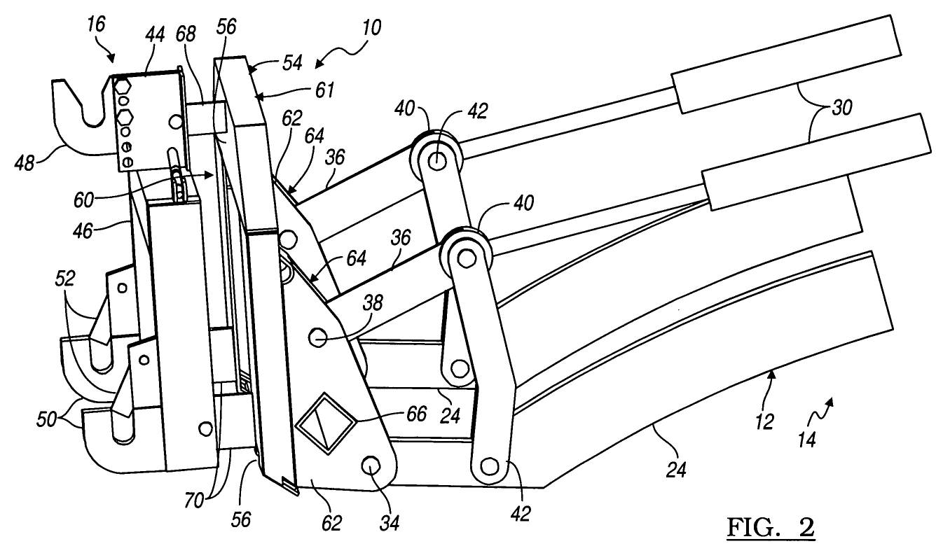

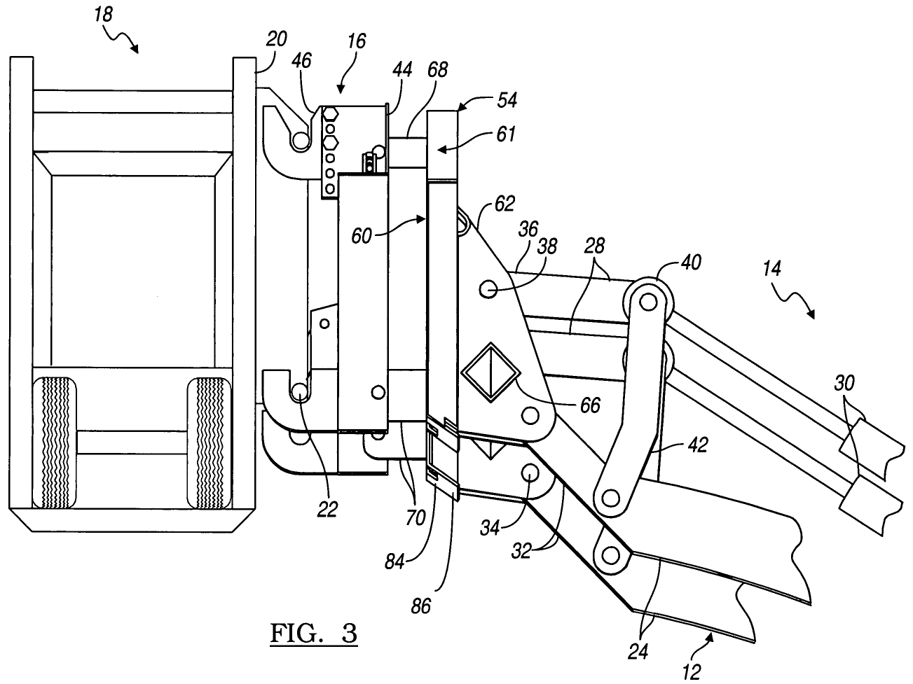

Referring in more detail to the drawings, FIG. 1 illustrates a mount apparatus 10 constructed according to one embodiment attached to front loader arms of a transporting vehicle, represented here as a front loader arm assembly of a front-end loader 14, for example, to facilitate attaching three-point implements to the front loader arms. As shown in FIG. 2, a quick-hitch apparatus 16 can be attached to the mount apparatus 10 to further facilitate attaching the desired three-point hitch implement to the loader arm assembly 12. As shown in FIG. 3, the three-point implement is represented, by way of example and without limitations, as a wheeled cart 18 having three-point hitch attachment points, including an upper center hitch point 20 and a pair of lower laterally spaced hitch points 22, arranged per known engineering standards for attachment to a standard three-point hitch. It should be recognized that any desired three-point hitch implement, such as a landscape rake, auger, or various blades, for example, could be attached to the front loader arm assembly 12 via the mount apparatus 10. It should also be recognized that the implements could be attached directly to the mount apparatus 10 without incorporating the quick-hitch apparatus 16. As such, the mount apparatus 10 provides a quick, economical and relatively easy mechanism in which to attach three-point implements to the front loader arm assembly 12, rather than to the rear end of the front-end loader 14. As such, with the implement attached to the loader arm assembly 12, the implement can be outstretched an increased distance and lowered to increased depths, thereby providing increased flexibility for maneuvering the implement, thus, enhancing the overall usefulness of the implement.

The front-end loader arm assembly 12 is represented here, for example, as having a pair of lower arms 24 movable upwardly and downwardly via a pair of actuators (not shown), and a pair of upper control link arms 28 movable fore and aft via another pair of actuators 30. The lower arms 24 have free ends 32 with through openings adjacent thereto for pivotal attachment via pins 34 to a standard bucket (not shown), for example, which is commonly provided as original equipment on the front-end loader 14. The upper control link arms 28 have free ends 36 with through openings adjacent thereto for pivotal attachment of the bucket via pins 38 thereto. The upper control link arms 28 have opposite ends 40 attached to the actuators 30, and also arranged for operable attachment to the lower arms 24 via a pair of pivot links 42. Accordingly, the lower arms 24 provide upward and downward movement of the implement, while the upper control link arms 28 provide tilting or pivoting movement of the implement.

As best seen in FIG. 3, the upper control link arms 28, lower control link arms 24, pivot link arms 42, and quick attach face plate assembly 62 of the mount apparatus 10 define a four-bar linkage, which allows for the controlled movement of the quick-hitch apparatus 16. In this regard, actuation of the upper actuator 30 and lower actuator allow for vertical, horizontal and rotational movement of the quick-hitch apparatus 16 with respect to the front-end loader 14.

The quick-hitch apparatus 16 can be of any type attachable to a three-point hitch, such as those readily available from Case New Holland under part number B91368, for example. The quick-hitch apparatus 16 has a rear surface 44 with three-point hitch attachment points, including an upper center hitch point and a pair of lower laterally spaced hitch points, as described above for the cart 18. An opposite front surface 46 of the quick-hitch apparatus 16 has three hooks (FIG. 2) arranged directly opposite the three-point attachment points. Accordingly, there is an upper central hook 48 and a pair of laterally spaced lower hooks 50, wherein the lower hooks 50 preferably have releasable locking mechanisms 52 to facilitate maintaining the implement attached thereto, while in use.

The mount apparatus 10 has a generally planar body 54, represented here, for example, as having a generally inverted u-shaped, with laterally spaced upright supports 56 (FIG. 1) attached to one another at an upper portion thereof via a cross support 58 extending between the upright supports 56. The body 54 has front and rear surfaces 60, 61, respectively, facing opposite directions from one another with a quick attach face plate assembly 62 extending laterally outwardly from the rear surfaces 61 of the upright supports 56.

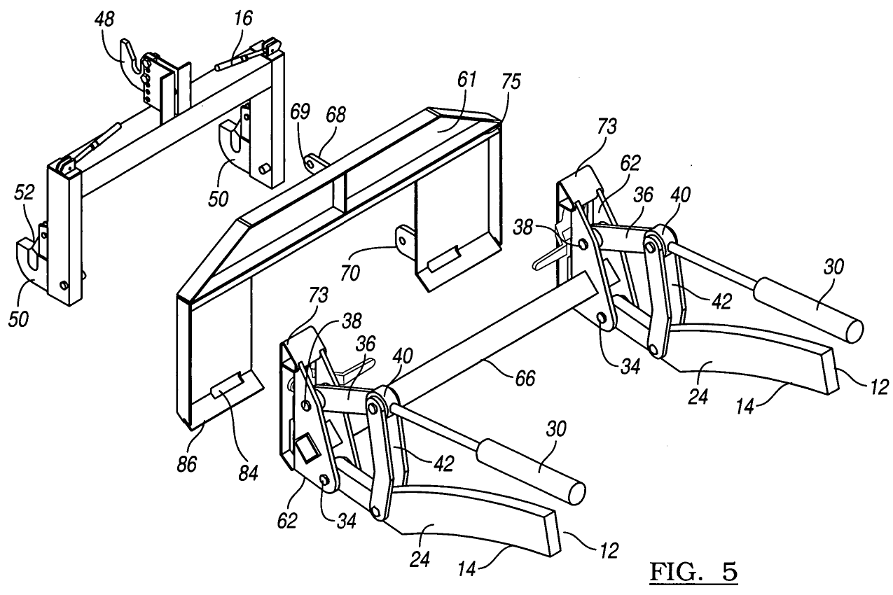

The quick attach face plate assembly 62 is arranged generally adjacent opposite sides of the body 54 and is arranged for close communication with the lower arms 24 and the upper control link arms 28. The quick attach face plate assembly 62, represented here, by way of example and without limitations, has a pair of parallel plates spaced from one another to define a pair of laterally spaced pockets 64 (FIG. 5). The pockets 64 are spaced from one another for close receipt of the lower arms 24 and the upper control link arms 28 therein. Each plate has a pair of through openings 33 and 35 arranged for axial alignment with respective ones of the through openings in the lower arms 24 and upper control link arms 28, such that the pins 34, 38 can be disposed through the aligned openings to pivotally attach the mount apparatus 10 to the loader arm assembly 12. Disposed within the pockets 64 is coupling mechanism 65. Coupling mechanism 65 has a selectively retractable or engagable pin 80. Pin 80, which is actuated by movement of lever arm 82, is configured to engage slot 84 defined within a lower flange 86 formed in the planar body 54.

Additional lateral rigidity can be provided to the mount apparatus 10, such as by incorporating a stabilizer between the quick attach face plate assembly 62. The stabilizer is represented here as a tubular cross beam 66 through the quick attach face plate assembly 62 generally midway between the through openings, for example. An upper bracket 68 extends laterally outwardly from the front surface 60 of the cross support 58, shown here, for example, as being centered equidistantly between the upright supports 56. The upper bracket 68 has a through opening 69 to facilitate attachment to the center hitch point 20 of the three-point hitch implement (not shown), or the quick-hitch apparatus 16, as desired. The upper bracket 68 can be attached to the body 54 with the use of fasteners, or, as represented here, by a weld joint, for example.

A pair of lower brackets 70 extends laterally outwardly from the front surface 60 of the body 54 with a separate one of the lower brackets 70 extending from opposite ones of the upright supports 56. The lower brackets 70 are spaced a predetermined distance beneath the upper bracket 68 and have through openings 71 to facilitate attachment to the lower hitch points 22 of the three-point hitch implement, or the quick-hitch apparatus 16, as desired.

In use, the mount apparatus 10 is attached to the loader arm assembly 12 by axially aligning the openings in the quick attach face plate assembly 62 with the respective openings in the lower arms 24 and the control link arms 28. The pins 34, 38 are then disposed therein to maintain the quick attach face plate assembly 62 in pivotally attached relation to the loader arm assembly 12. The apparatus 10 is then coupled to the quick attach face plate assembly 62. In this regard, a coupling surface 73 is disposed within a hook surface 75 defined in the planar body 54. Lever arms 82 are engaged so as to allow engagement of the pins 80 in the slots 84, thus locking the apparatus 10 to the quick attach face plate assembly 62. Upon being attached to the loader arm assembly 12, the desired implement can be attached directly to the mount apparatus 10 by aligning the upper center hitch point 20 and the pair of lower laterally spaced hitch points 22 of the implement with the through opening 69 in the upper bracket 68 and the through openings 71 in the lower brackets 70, respectively. Pins or carriage bolts can then be used to secure the implement directly to the mount apparatus 10, or the quick-hitch apparatus 16 can be attached to the mount apparatus 10, thereby allowing the desired implement to be quickly attached to the arm assembly 12 of the front-end loader 14.

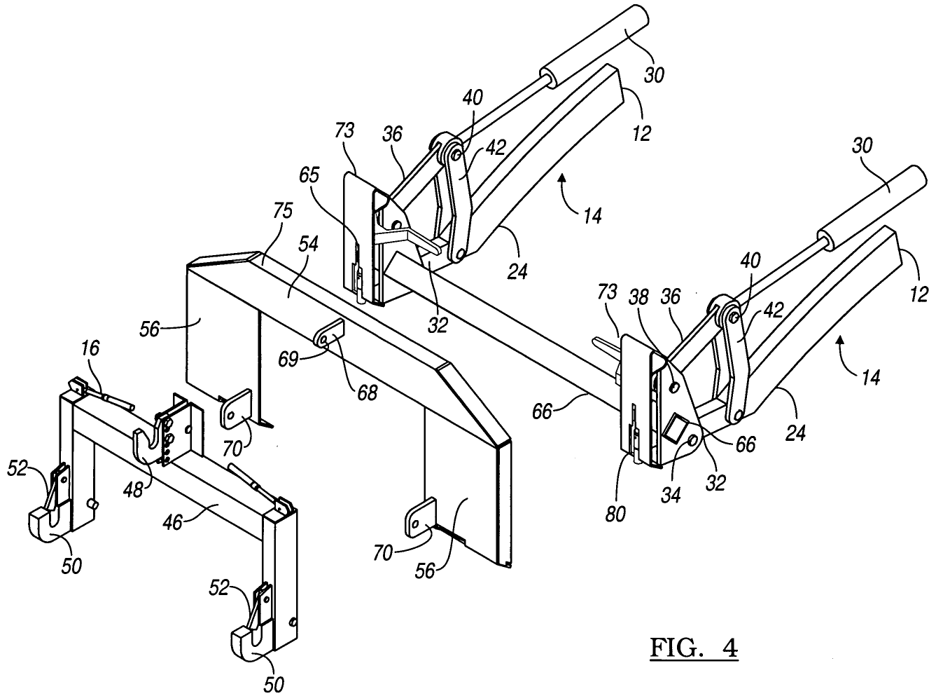

FIGS. 4 and 5 represent front and rear perspective exploded views of the relationship of the mount apparatus 10 coupled to the lower arm assembly 12. Generally, the mount apparatus 10 functions as a coupling mechanism between the upper and lower hooks 48 and 50, the lower arms 24, and the control link arms 28. Further, by functioning as an element of a four-bar linkage, the apparatus 10 allows for manipulations of a device held by the central and lower hooks 48 and 50. By varying the location of the through openings 33 and 35 within respect to each other, adjustments of the movement and connection angle of the implement can be made. As such, it is envisioned, a plurality of holes 33 that represent mounting locations for the lower arm can be defined in the bracket. Similarly, a plurality of holes 35 can be defined in the quick attach face plate assembly 62 for facilitating coupling of the mount apparatus 10 to the control link arms 28.

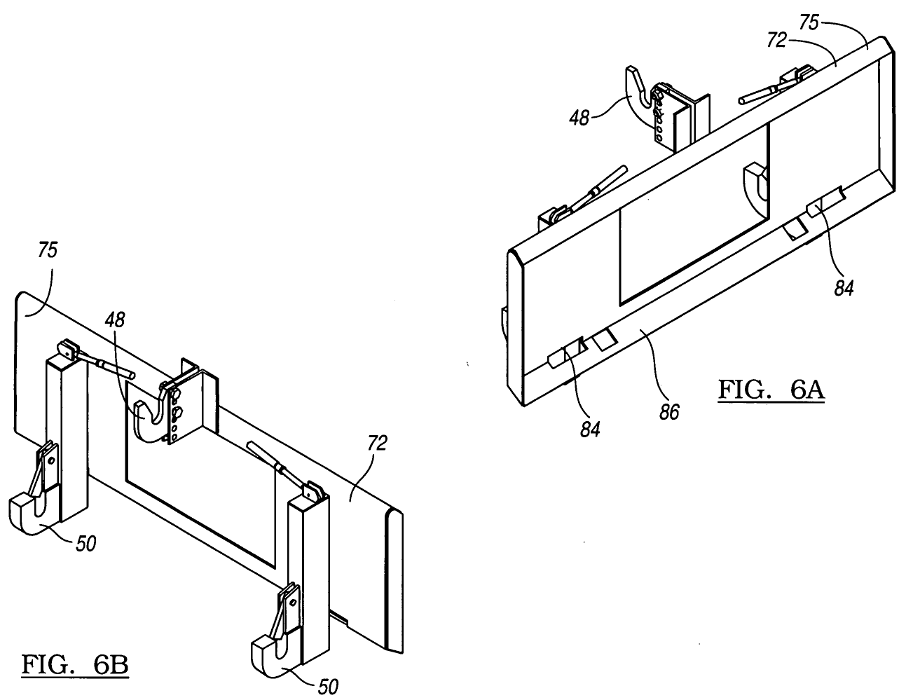

FIGS. 6A and 6B represent an alternate mount apparatus 72 according to one embodiment of the present teachings. Coupled directly to the planar body 54 are the central and lower hooks 48 and 50 disposed on the front surface 60. Further coupled to a rear surface 61 is the quick attach face plate assembly 62. The general planar body 54 can be formed of a single stamped piece of sheet metal or can be formed of a plurality of metal components which are welded or fastened together.

The central hook 48 is coupled to the planar body 54 by a coupling bracket 74. The coupling bracket 74, which is welded or bolted to the planar body 54, has a plurality of vertically displaced holes 76, which allow for adjustment of the center hook 48 with respect to the lower hooks 50.

As described above, the lower hooks 50 can also have an associated locking mechanism 52. It is envisioned the locking mechanism 52 can additionally have an automatic or manual actuator 78 which functions to engage or disengage the locking mechanism 52. As described above, pins 34 and 38 are used to couple the controlling arms 28 and free ends 32 of the lower arms 24 to the quick attach face plate assembly 62. Engagement of the actuator 30 or the actuator of the lower arm 24 will cause the rotation or vertical translation of the alternate mount apparatus 72 and associated implement.

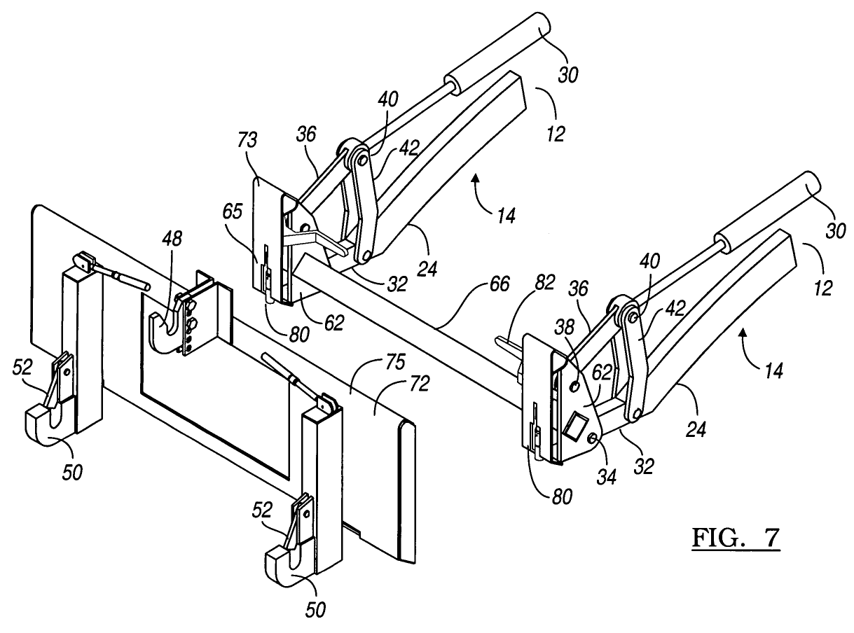

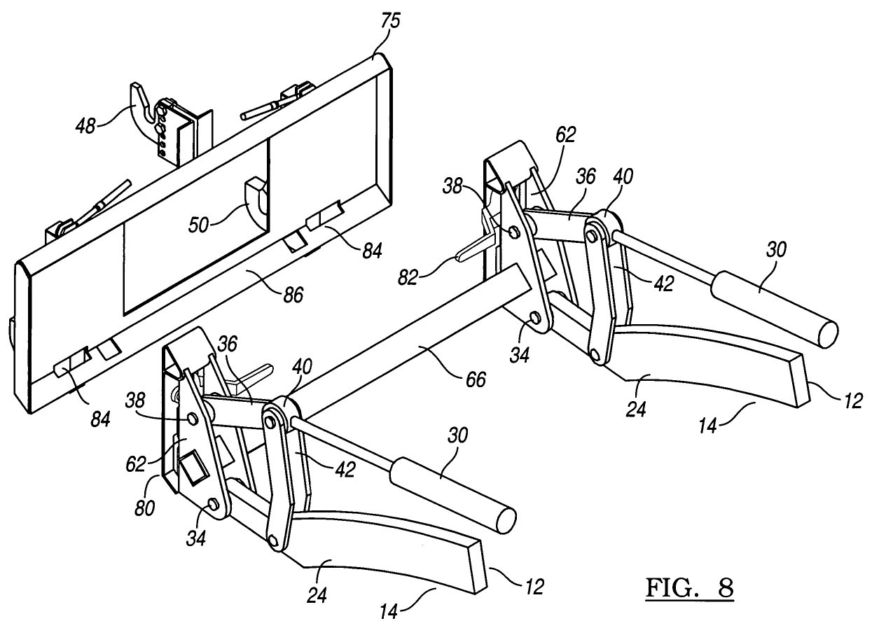

As shown in FIGS. 7 and 8, the mounting apparatus 72 couples the central and lower hooks 48 and 50 directly to the controlling arms 28 and the lower arms 24 utilizing pins 34 and 38. As described above, the quick attach face plate assembly 62 of the mounting apparatus 72 by functioning as an element of a four-bar linkage. This allows for vertical, horizontal and rotational manipulations of a device held by the central and lower hooks 48 and 50. The direct coupling of the central and lower hooks 48 and 50 to the planar body 54 allow for a quick coupling of the mounting apparatus 72 to both loader arm assembly and to a three point implement.

The embodiments of the mount apparatus 10 and 72 and associated transporting vehicle 14 discussed above are intended to be illustrative of presently preferred embodiments, and not limiting. Various modifications within the spirit and scope of the invention will be readily apparent to those skilled in the art. The invention is defined, at least in part, by the claims that follow.

What is claimed is:

1. A mount apparatus for attaching a three-point hitch implement to front arms of a front-end loader, comprising:
a quick-coupler mechanism;
a body coupled to the quick-coupler mechanism; and
a plurality of arm coupling brackets, said brackets being rotatably coupled to the front arms of the front-end loader.

2. The apparatus according to claim 1 wherein said body comprises a plurality of coupling flanges disposed between the body and the quick-coupler mechanism.

3. The apparatus according to claim 1 wherein the front arms comprise top and bottom linkages, said arm coupling brackets coupled to the top and bottom linkages to form a four-bar linkage.

4. The apparatus according to claim 1 wherein the arm coupling brackets extend generally perpendicular to a rear surface of said body, each flange having a pair of openings adapted for pivotal attachment to the front arms of the front-end loader.

5. The apparatus according to claim 1 wherein said body comprises a pair of laterally spaced upright supports and a cross support extending there between.

6. An apparatus according to claim 1 further comprising an upper bracket extending laterally from the body, said upper bracket being adapted to be coupled to a center hitch point of said quick-coupler mechanism.

7. The apparatus according to claim 1 wherein said quick-coupler mechanism comprises a pair of lower hooks each having a releasable locking mechanism.

8. The apparatus according to claim 7 further comprising an upper hook displaced relative to, but disposed between said pair of lower hooks.

9. A mounting apparatus for attaching a three-point implement to front arms of a front arm loader, said apparatus comprising:
a generally planar body;
a pair of flanges extending laterally in a first direction from said body, each flange defining a pair of openings adapted for pivotal attachment to the front arms of the front arm loader;
an upper bracket extended in a second direction from said body, said upper bracket adapted for attachment to a center hitch point of the three-point hitch implement; and
a pair of lower brackets extending in the second direction from said body, said lower brackets being a predetermined distance away from said upper bracket, and further being adapted for attachment to a pair of laterally spaced hitch points of the three-point hitch implement.

10. The apparatus according to claim 9 wherein the body comprises a pair of laterally spaced supports and a cross support extending there between.

11. The apparatus according to claim 9 further comprising a three-point implement releasably coupled to said body.

12. The apparatus according to claim 9 further comprising a quick-coupler mechanism coupled to upper and lower brackets.

13. The apparatus according to claim 9 wherein the front arms each comprise top and bottom linkages, said flanges being rotatably coupled to the top and bottom linkages to form a four-bar linkage.

14. The apparatus according to claim 13 further comprising a first actuator coupled to the lower linkage and a second actuator coupled to the upper linkage.

15. The apparatus according to claim 13 further comprising a pivot link coupled to the top and bottom arms to define a four-bar linkage.

16. A method of attaching a three-point hitch implement to a front end of a front-end loader, the front end having a pair of front loader arms and a pair of control link arms, comprising the steps of:
attaching a body for pivotal movement to said control link arms and said front loader arms;
attaching a three-point quick-hitch apparatus to said body; and
attaching said three-point hitch implement to said three-point quick-hitch apparatus.

17. The method according to claim 16 wherein attaching a three-point quick-hitch implement to said body is removably coupling the three-point quick-hitch implement to a plurality of brackets on the body.

18. The method according to claim 16 wherein attaching said three-point hitch implement to said three-point quick-hitch apparatus is coupling said three-point hitch implement to a plurality of hooks disposed on said three-point quick-hitch apparatus.

19. The method according to claim 16 wherein attaching a body is axially aligning openings in flanges on the body with respective openings in the lower arms and control link arms.

20. The method according to claim 19 further including disposing pins within the aligned openings to maintain the body in pivotal attachment with said loader arms.
